(19) United States
(12) Patent Application Publication
(10) Pub. No.: US 2024/0265252 A1
(43) Pub. Date: Aug. 8, 2024

(54) MEASURING A VALUE OF A PHYSICAL VARIABLE OF A TECHNICAL SYSTEM

(71) Applicant: Siemens Aktiengesellschaft, München (DE)

(72) Inventors: Andrés Botero Halblaub, Kirchseeon (DE); Harald Held, Bockhorn (DE); Veronika Brandstetter, München (DE)

(21) Appl. No.: 18/565,706

(22) PCT Filed: May 31, 2022
(86) PCT No.: PCT/EP2022/064689

§ 371 Date: Nov. 30, 2023

(30) Foreign Application Priority Data
Jun. 8, 2021 (EP) 21178316.2

(51) Int. Cl. G06N 3/08

(52) U.S. Cl. CPC G06N 3/08

(57) ABSTRACT

An apparatus, such as a virtual sensor, for measuring a value of a physical variable of a technical system includes a generative machine learning model that is trained, e.g., on the basis of generative adversarial networks (GANs for short), in such a way as to take at least one value of a first physical variable of a technical system as a basis for generating and outputting at least one value of a second physical variable of the technical system. The apparatus is configured in such a way as to use the generative machine learning model to generate and output a value of a second physical variable of the technical system on the basis of a measured value of a first physical variable of the technical system.

### CROSS-REFERENCE TO RELATED APPLICATIONS

This application claims priority to PCT Application No. PCT/EP2022/064689, having a filing date of May 31, 2022, which claims priority to EP Application No. 21178316.2, having a filing date of Jun. 8, 2021, the entire contents both of which are hereby incorporated by reference.

### FIELD OF TECHNOLOGY

The following relates to an apparatus, a computer-implemented method and a computer program product for recording a value of a physical variable of a technical system by means of a generative machine learning model, such as, for example, generative adversarial networks. The following also relates to a computer-implemented method and a computer program product for providing such a generative machine learning model.

### BACKGROUND

During operation of a technical system, parameters or physical variables of a technical system, such as, for example, temperature, pressure, etc., can be recorded, and thus monitored, by means of physical or real sensors. However, often not all physical variables of a technical system can be measured in this way, for example because a measuring position is not accessible or only poorly accessible. In order, nevertheless, to determine values of such physical variables, Kalman filters are usually used as virtual sensors in order to estimate states that cannot be measured or can only be measured poorly. Such estimates, however, require simple computer-aided simulation models to calculate the estimates in a short time. However, simple quickly calculated simulation models for complex physical processes are often not available.

### SUMMARY

An aspect therefore relates to simplify the estimation of values of physical variables of a technical system.

According to a first aspect, embodiments of the invention relate to an apparatus for recording a value of a physical variable of a first technical system, wherein the first technical system is characterized by a first system specification, comprising:
an interface which is configured to read in a measured value of a first physical variable of the first technical system recorded by means of a physical sensor,
a memory unit which is configured to store a generative machine learning model,
   wherein the generative machine learning model is configured to generate and output, in dependence on at least one value of a first physical variable of a second technical system, at least one value of a second physical variable of the second technical system,
   wherein the second technical system is characterized by a second system specification and the second system specification at least partially coincides with the first system specification,
a measured value generator which is configured to generate, by means of the generative machine learning model, a value of a second physical variable of the first technical system in dependence on the measured value of the first physical variable, wherein the first physical variable of the first technical system corresponds to the first physical variable of the second technical system and the second physical variable of the first technical system corresponds to the second physical variable of the second technical system, and
an output unit which is configured to output the generated value of the second physical variable of the first technical system.

Unless specified otherwise in the following description, the terms “perform”, “calculate”, “computer-aided”, “compute”, “identify”, “generate”, “configure”, “reconstruct” and the like relate to actions and/or processes and/or processing steps that alter and/or generate data and/or convert data into other data, wherein the data is, or can be, in particular represented or available as physical variables, for example as electrical pulses. In particular, the expression “computer” should be interpreted as broadly as possible in order in particular to cover all electronic devices with data processing properties. Thus, computers can, for example, be personal computers, servers, programmable logic controllers (PLCs), handheld-computer systems, pocket PC devices, mobile radio devices and other communication devices that can process data in computer-aided fashion, processors and other electronic devices for data processing.

In the context of embodiments of the invention, a “memory unit” can, for example, be understood to mean a volatile memory in the form of random-access memory (RAM) or a permanent memory such as a hard disk or data carrier.

In the context of embodiments of the invention, a “unit” can, for example, be understood to mean a processor for storing program instructions. For example, the processor is specially configured to execute the program instructions such that the processor executes functions for implementing or realizing the method according to embodiments of the invention or a step of the method according to embodiments of the invention.

In the context of embodiments of the invention, “provision”, in particular with regard to data and/or information, can, for example, be understood to mean computer-aided provision. Provision takes place, for example via an interface, such as, for example a network interface, a communication interface or an interface to a memory unit. Such an interface can, for example, be used to transmit and/or send and/or retrieve and/or receive corresponding data and/or information during provision.

A “technical system” can in particular be understood to mean a machine, a device or even a plant, such as, for example, a factory plant comprising a plurality of machines and/or devices. For example, the technical system is a production machine, a machine tool, or the like. A technical system can, for example, also be a motor or a turbine.

A “system specification” can in particular be understood to be a technical specification describing a technical variable, property or technical feature of the technical system. The technical system can be characterized by the system specification, i.e., the system specification is specific to a technical system. For example, a system specification is a parameter or type/system type of the technical system. A system specification can in particular also be referred to as a specification.

A “physical sensor” can in particular be understood to mean a detector, a measured variable transducer or measuring transducer or measuring sensor. A physical sensor is in particular a hardware component or a hardware part (hardware sensor) that quantitatively records/measures physical and/or chemical properties and/or material properties of a technical system. The sensor outputs a measured value or value of the measured variable. Physical variables can be pressure, weight, acceleration, light intensity, temperature, humidity, radiation, sound, magnetic flux, speed, etc.

A “generative machine learning model” can in particular be understood as an artificial neural network which is configured to generate data. The generative machine learning model is trained by means of training data, wherein weightings of the artificial neurons are set to reproduce output data in dependence on input data. The generative machine learning model can in particular be an estimator based on generative adversarial networks.

It is an advantage of embodiments of the present invention that values of physical variables of a technical system can be estimated in a simple way without having to measure them by means of a real sensor. For this purpose, a generative machine learning model is trained and provided in order to output a value of a physical variable in dependence on a measured value of the technical system. In particular, it is also possible to calculate a temporal prediction of a value in dependence on a specified measured value. The estimation or prediction is in particular computationally more efficient than performing computer-aided simulation. The apparatus is also able to supply continuous values of a physical variable, whereas real measurements are often discontinuous. The apparatus can thus in particular be understood as a virtual sensor.

In one embodiment of the apparatus, the generative machine learning model can be configured by means of generative adversarial networks.

Generative adversarial networks (GANs) belong to the category of artificial neural networks. They can be used to generate data—unlike other artificial neural networks that typically classify data. Generative adversarial networks consist of two neural networks that are combined. Training of the two neural networks has two opposite goals. One network is referred to as a discriminator, the other as a generator. The two networks are trained jointly by means of training data such that the generator generates (synthetic) data that the discriminator classifies as authentic. After training, the generator can be output and used as a generative machine learning model, also referred to as an estimator. Generative adversarial networks can in particular also be used for time-dependent applications, such as, for example, for predicting data.

In one embodiment of the apparatus, the generative machine learning model can be configured to generate, in dependence on at least one value of a first physical variable of the second technical system at a first time, at least one value of a second physical variable of this technical system at a second time, wherein the second time is later than the first time.

In particular, the apparatus can output a prediction of future measured values. For this purpose, the generative machine learning model is configured such that, in dependence on a specified value at a first time, it can output a value of a physical variable at a later time.

In one embodiment of the apparatus, the value of the second physical variable of the first technical system cannot be measured directly or cannot be measured sufficiently by means of a physical sensor.

The apparatus can be used to determine values of physical variables that cannot be measured, can only be measured with difficulty or can only be measured inaccurately by means of a real sensor. For example, this can entail a value of a variable at a measuring position that is difficult to access, or cases where the ambient conditions prevent the use of a real sensor/hardware sensor. The apparatus can also be used to determine a plurality of values without requiring a corresponding number of physical sensors. This in particular saves costs.

In one embodiment of the apparatus the generative machine learning model can be configured based on simulation data of a computer-aided simulation of the second technical system, wherein the simulation data comprises at least one value of the first physical variable and at least one value of the second physical variable of the second technical system.

The generative machine learning model is trained by means of training data and provided trained. The learning model is trained for a technical system that corresponds at least partially to the first technical system. Training data can be simulation data of a computer-aided simulation of the second technical system. In particular, the learning model can be based on a complex computer-aided simulation for a second technical system.

In one embodiment of the apparatus, the generative machine learning model can be configured based on measured values of the second technical system, wherein the measured values comprise at least one value of the first physical variable and at least one value of the second physical variable of the second technical system.

Alternatively or additionally to the simulation data, the training data can also comprise measured values of the second technical system.

In one embodiment, the apparatus can comprise a computing unit for artificial intelligence.

In the context of embodiments of the invention, a “computing unit for artificial intelligence” can in particular be understood to be an AI accelerator or a neural processing unit (NPU). Such a computing unit is a computing unit that is specifically suitable for computing artificial intelligence, i.e., a specific computing unit for AI or a computing unit that is suitable for executing an AI-based application.

In one embodiment, the apparatus can be realized as a virtual sensor.

A virtual sensor—also referred to as a soft sensor—is in particular configured to estimate/calculate, in dependence on at least one measured value and by means of the generative machine learning model, a value of a further physical variable.

A further aspect of embodiments of the invention relates to a computer-implemented method for recording a value of a physical variable of a first technical system, wherein the first technical system is characterized by a first system specification, with the method steps:
reading in a measured value of a first physical variable of the first technical system recorded by means of a physical sensor,
reading in a generative machine learning model, wherein
   the generative machine learning model is configured to generate and output, in dependence on at least one value of a first physical variable of a second technical system, at least one value of a second physical variable of the second technical system,
   and the second technical system is characterized by a second system specification and the second system specification at least partially coincides with the first system specification,
generating a value of a second physical variable of the first technical system in dependence on the measured value of the first physical variable by means of the generative machine learning model, wherein the first physical variable of the first technical system corresponds to the first physical variable of the second technical system and the second physical variable of the first technical system corresponds to the second physical variable of the second technical system, and
outputting the generated value of the second physical variable of the first technical system.

The method can in particular be at least partially computer-aided or computer-implemented. In the context of embodiments of the invention, “computer-aided can for example be understood as an implementation of the method in which in particular a processor executes at least one method step of the method. In the context of embodiments of the invention, a processor can, for example, be understood to be a machine or an electronic circuit. A processor can in particular be a central processing unit (CPU), a microprocessor or a microcontroller, for example an application-specific integrated circuit or a digital signal processor, possibly in combination with a memory unit for storing program instructions, etc. A processor can, for example, also be an IC (integrated circuit), in particular a FPGA (field programmable gate array) or an ASIC (application-specific integrated circuit), or a DSP (digital signal processor) or a GPU (graphic processing unit). A processor can also be understood to be a virtualized processor, a virtual machine or a soft CPU. It can also be, for example, a programmable processor that is equipped with configuration steps for executing said method according to embodiments of the invention or is configured with configuration steps such that the programmable processor realizes the features according to embodiments of the invention of the method, the component, the modules, or other aspects and/or partial aspects of embodiments of the invention.

A further aspect of embodiments of the invention relates to a computer-implemented method for providing a generative machine learning model for use in an aforementioned method, with the method steps:
reading in training data of a technical system, wherein the training data comprises at least one value of a first physical variable and at least one value of a second physical variable of the technical system,
reading in a generative machine learning model,
training the generative machine learning model by means of the training data and a discriminator network such that the generative machine learning model generates and outputs the value of the second physical variable in dependence on the value of the first physical variable, and
outputting the trained machine learning model for recording a value of a physical variable of a technical system.

In one embodiment of this method, the training data can be simulation data of a computer-aided simulation and/or measurement data of the technical system.

Furthermore, embodiments of the invention relates to a computer program product (non-transitory computer readable storage medium having instructions, which when executed by a processor, perform actions), which can be loaded directly into a programmable computer, comprising program code portions which, when the program is executed by the processor, cause the computer to execute the steps of a method according to embodiments of the invention.

A computer program product can, for example, be provided or supplied on a storage medium, such as, for example, a memory card, USB stick, CD-ROM, DVD, a non-transitory storage medium or also in the form of a downloadable file from a server in a network.

### BRIEF DESCRIPTION

Some of the embodiments will be described in detail, with reference to the following figures, wherein like designations denote like members, wherein:

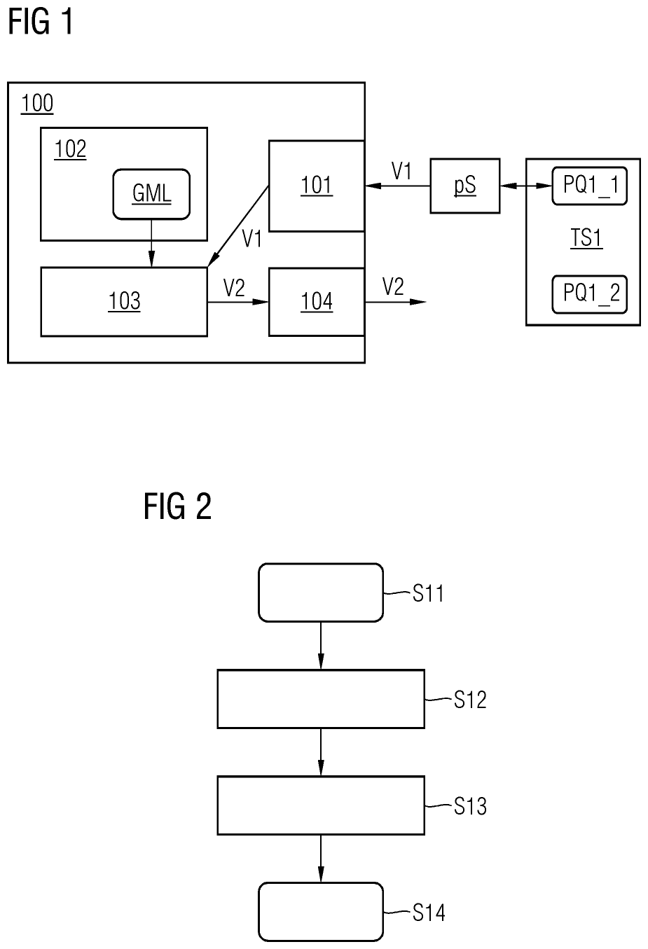

FIG. 1 shows an exemplary embodiment of the apparatus according to the invention;

FIG. 2 shows an exemplary embodiment of the method according to the invention for recording a value of a physical variable of a first technical system;

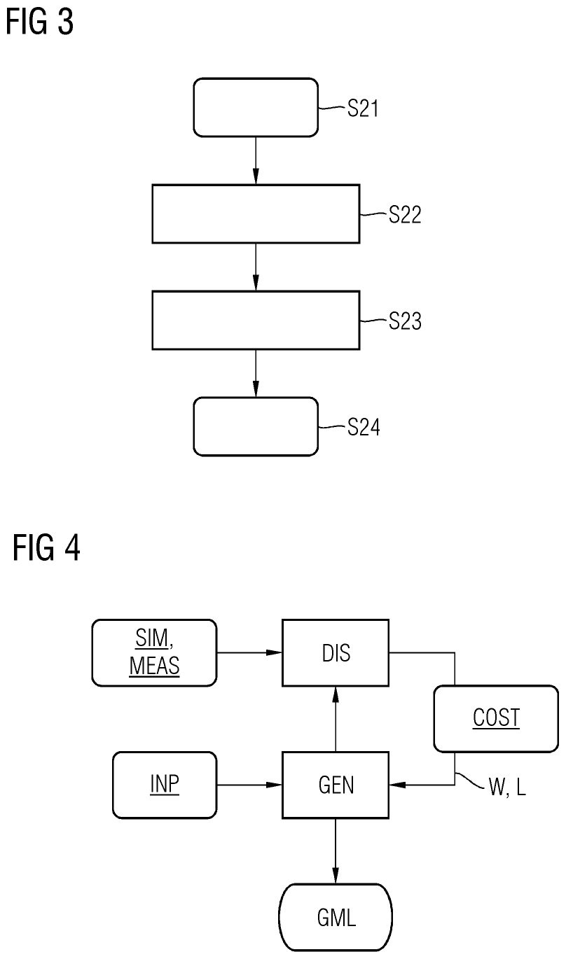

FIG. 3 shows an exemplary embodiment of the method according to the invention for providing a generative machine learning model;

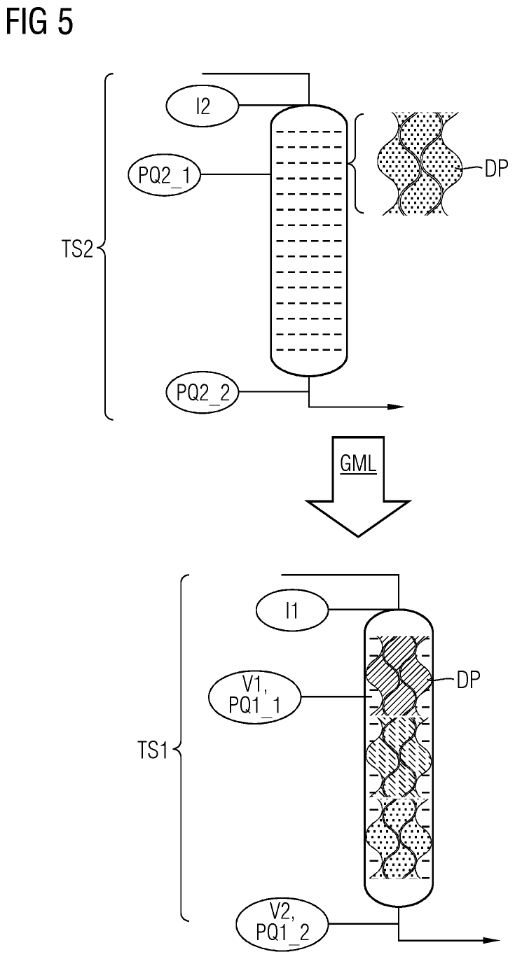

FIG. 4 shows a further exemplary embodiment of the method according to the invention for providing a generative machine learning model; and

FIG. 5 shows a further exemplary embodiment of the method according to the invention for recording a value of a physical variable of a first technical system.

### DETAILED DESCRIPTION

Corresponding parts are given the same reference symbols in all the figures.

The following exemplary embodiments in particular only show exemplary realization possibilities, in particular how such realizations of the teaching according to embodiments of the invention could appear, since it is impossible and also not purposeful or necessary for understanding embodiments of the invention to name all these realization possibilities.

Also, in particular all possibilities for the realization of products or possibilities for implementation that are common in the conventional art are known as a matter of course to a (relevant) person in the art with knowledge of the method claim(s) so that in particular no independent disclosure is required in the description. In particular, these common realization variants known to the person skilled in the art can be realized exclusively by hardware (components) or exclusively by software (components). Alternatively and/or additionally, those skilled in the art can select any combination of hardware (components) and software (components) within the scope of their skill in the art in order to implement realization variants.

FIG. 1 is a schematic view of an exemplary embodiment of an apparatus 100 according to embodiments of the invention for recording a value of a physical variable of a first technical system TS1. The first technical system TS1 can, for example, be an electrical machine, such as, for example, a motor. The first technical system TS1 in particular has a system specification describing, for example, parameters and/or a type of the technical system TS1. For example, the system specification of the motor describes a power or a motor type.

The motor TS1 has various physical variables that can be measured or monitored by means of physical sensors/hardware sensors pS. For example, a first physical variable PQ1_1, a speed of the motor TS1, can be measured by means of a physical sensor pS and at least one measured value V1 can be recorded.

A value of a second physical variable PQ1_2 of the motor TS1 is to be ascertained. For example, the second physical variable PQ1_2 is a temperature of the motor, which, for example, cannot be recorded by a real sensor or can only be measured with difficulty or with a degree of uncertainty by a real sensor.

The first physical variable PQ1_1 and the second physical variable PQ1_2 can in particular be different. For example, the first physical variable PQ1_1 can be a speed of the motor and the second physical variable can be a temperature of the motor TS1.

Alternatively, the first physical variable PQ1_1 and the second physical variable PQ1_2 can also be the same or similar. For example, both physical variables PQ1_1, PQ1_2 can then relate to a temperature, for example at different positions of the motor TS1.

Thus, the first and the second physical variable can be the same but recorded at different positions and/or at different times on the technical system. There is a correlation between the first physical variable PQ1_1 and the second physical variable PQ1_2. Thus, a machine learning model can be trained to reproduce this correlation.

The apparatus 100 can, for example, be embodied as a virtual sensor. The apparatus 100 comprises an interface 101, a memory unit 102, a measured value generator 103 and an output unit 104.

The interface 101 can in particular be coupled to the physical sensor pS. The interface 101 is configured to read in the measured value V1 of the first physical variable PQ1_1. The interface 101 can read in further measured values of further physical variables of the motor TS1. In particular, the interface 101 can read in measured values continuously or at regular time intervals.

The memory unit 102 stores a trained generative machine learning model GML, for example a trained generator or estimator that has been conditioned/trained by means of generative adversarial networks.

The generative machine learning model GML is configured to generate and output, in dependence on at least one value of a first physical variable of a second technical system, at least one value of a second physical variable of the second technical system, wherein the second technical system is characterized by a second system specification and the second system specification at least partially coincides with the first system specification. The generative machine learning model GML is trained for a technical system corresponding to the first technical system, i.e., the motor TS1, according to a specification. The second technical system is likewise a motor TS2. This second motor TS2 is likewise characterized by a system specification, for example a motor type. Thus, it is, for example, possible to check whether the system specifications, such as, for example, the motor types, of the first motor TS1 and the second motor TS2 match in order to ascertain whether the generative machine learning model GML is suitably configured for the first motor TS1.

Alternatively, the generative machine learning model GML can also have been trained for the first technical system TS1, i.e., in this case, the second technical system TS2 matches the first technical system TS2.

The generative machine learning model GML was trained by means of simulation data and/or measurement data from the second technical system.

The generative machine learning model GML can in particular be configured to specify, in dependence on a measured value at a first time, a value of a physical variable at a later time. Consequently, the generative machine learning model GML can be used to predict a measured value.

The generative machine learning model GML and the measured value V1 are read in by the measured value generator 103. The measured value generator is configured to determine a value V2 of the temperature PQ1_2 of the motor TS1 by means of the generative machine learning model GML. For this purpose, the measured value V1 is transferred to the generative machine learning model GML and this is executed. Thus, the measured value generator determines a value V2 of the temperature PQ1_2 in dependence on the measured value V1.

The memory unit 102 can, for example, comprise a plurality of generative machine learning models GML suitable for the first technical system/the motor TS1. Suitability can in particular be ascertained based on the system specification. A respective generative machine learning model is in particular configured to generate a value of a predetermined physical variable in dependence on a value of a predetermined physical variable.

The apparatus 100 can, for example, comprise a selection unit (not shown) configured to select, in dependence on the first physical variable PQ1_1, a suitable generative machine learning model, which is configured to generate a value of a second physical variable in dependence on the measured value of this first physical variable PQ1_1.

The output unit 104 is configured to output the measured value V2 of the temperature PQ1_2. For example, the motor TS1 can be monitored or controlled based on this temperature value V2. It is also possible to use the temperature value V2 to detect a malfunction of the motor TS1.

The apparatus 100 can, for example, comprise a computing unit for artificial intelligence, such as, for example, a neural processing unit, which is configured to execute the generative machine learning model GML efficiently. The apparatus 100 can, for example, be attached to the actual technical system TS1. Alternatively, the apparatus 100 can also be realized as only coupled to the technical system, for example, in the cloud.

FIG. 2 shows an exemplary embodiment of a method according to embodiments of the invention for recording a value of a physical variable of a first technical system as a flowchart.

In the first step S11 of the method, a measured value of a first physical variable of the first technical system is read in. The measured value was, for example, recorded by means of a real sensor.

In the next step S12 of the method, a generative machine learning model is provided. For example, the generative machine learning model is stored in a memory unit from where it is retrieved. For example, the generative machine learning model is available as a graph in a data structure and can be read in in this way.

The first step S11 and the second step S12 can also be performed in parallel or in reverse order.

The generative machine learning model is in particular suitable for generating or predicting values of a physical variable of the technical system. For this purpose, the generative machine learning model for a second technical system is trained based on provided training data to generate at least one value of a second physical variable of the second technical system in dependence on at least one value of a first physical variable of the second technical system. Thus, the generative machine learning model is specifically configured for these physical variables of this technical system. The second technical system substantially corresponds to the first technical system, i.e., the system specification of the first technical system substantially corresponds to the system specification of the second technical system. This can, for example, be ascertained by comparing the respective system specifications of the first and second technical system. In other words, it is, for example, possible to check whether the first technical system substantially corresponds to the second technical system. For example, the systems may be of the same type and/or parameters of the first and second system may match. In other words, the generative machine learning model is trained for the first technical system, wherein for example simulation data and/or measurement data of a second technical system can be used.

In particular, a system specification of the first technical system can be used to select a generative machine learning model that has been trained for a second technical system, wherein the system specification of the second technical system is compared with the system specification of the first technical system. For example, the generative machine learning model has been configured based on training data from a complex computer-based simulation of a second technical system, as explained by way of example with reference to FIG. 3.

In the next step S13, the trained generative machine learning model is executed. Herein, a value of a second physical variable of the first technical system is determined in dependence on the read-in measured value of the first technical system, wherein the first physical variable of the first technical system corresponds to the first physical variable of the second technical system and the second physical variable of the first technical system corresponds to the second physical variable of the second technical system. Thus, it is in particular possible for a check to be performed, wherein it is checked whether the first physical variable of the first technical system corresponds to the first physical variable of the second technical system and the second physical variable of the first technical system corresponds to the second physical variable of the second technical system. If the result of the check is positive, the generative machine learning model can be executed.

Thus, in particular a value of the first physical variable of the first technical system that corresponds to the first physical variable of the second technical system is transmitted to the generative machine learning model. Then, the generative machine learning model only outputs a value of a physical variable that corresponds to the second physical variable of the second technical system.

The measured value is transferred to the generative machine learning model as an input value. The trained learning model uses this measured value to generate a value of a second physical variable of the first technical system.

In the next step S14, the generated value of the second physical variable of the first technical system is output.

FIG. 3 shows an exemplary embodiment of a method according to embodiments of the invention for providing a generative machine learning model as a flowchart. The generative machine learning model is, for example, configured/trained to record a value of a physical variable of a first technical system and is provided in this way.

In the first step S21 of the method, training data of a technical system is read in. The training data comprises at least one value of a first physical variable and at least one value of a second physical variable of this technical system. The first physical variable and the second physical variable are correlated. The training data can, for example, be simulation data of a computer-aided simulation of the technical system and/or measurement data of the technical system.

The generative machine learning model can, for example, be configured by means of generative adversarial networks (GMLs). Here, these are in particular artificial neural networks. One of these networks is called the discriminator and the other the generator. In the case of a set of training data, i.e., pairs of input data x and output data y, the discriminator network is trained to predict p(y|x), i.e., the probability of obtaining y for specific inputs x. On the other hand, the generator is trained to determine the probability for corresponding features x, i.e., p(x|y). In other words, the generator is trained to find x for specific outputs y. For example, the input data x is the at least one value of the first physical variable and the output data y is the at least one value of the second physical variable. The interaction between these two networks is substantially a zero-sum game against each other: the generator attempts to generate new data instances, which are then fed to the discriminator network which decides whether this data is actual data or data generated by the generator network. Consequently, training the generator means generating synthetic data that the discriminator considers to be authentic. In other words, while the discriminator attempts to tell the difference between real and generated data, the generator attempts to generate data to deceive the discriminator.

Consequently, the generator can be configured such that the generator generates and outputs values of a second physical variable. The trained generator or estimator can then be output as a trained generative machine learning model.

The generative machine learning model is trained based on the training data such that it outputs a value for a predetermined second physical variable in dependence on a specified value of a first physical variable. Consequently, the learning model is trained to determine values for a specified physical variable of a technical system. Thus, the generative machine learning model learns to reproduce the specified values. This enables the realization of a virtual sensor that outputs values for a specific physical variable. Additionally, the generative machine learning model can also be trained to output values for a future time. Thus, the generative machine learning model can be used to predict values.

In particular, the generative machine learning model can be trained to output a value for a second physical variable at a specific time in dependence on a first physical variable at a previous time. For this purpose, in particular training data with time stamps is provided in order to train a time dependency.

In the next step S24, the trained generative machine learning model is output. For example, the trained learning model can be output as a computational graph.

FIG. 4 is a schematic representation of a further exemplary embodiment of the method according to embodiments of the invention for providing a generative machine learning model, for example for an apparatus as shown in FIG. 1.

The generative machine learning model GML, which is configured to estimate a value of a physical variable of a technical system, can be trained on the basis of generative adversarial networks. Generative adversarial networks comprise a discriminator network DIS and a generator network GEN, wherein both are embodied as artificial neural networks.

Training data is required for the training, also referred to as conditioning, of these artificial neural networks. During the training, the weights W of the artificial neural networks are adapted. Additionally, the layers L of the artificial neural networks can also be adapted. The layers L are defined before training.

The training data provided is, for example, simulation data SIM of a computer-aided simulation of a technical system and/or measurement data or sensor data MEAS of the technical system. The measurement data MEAS is data from detailed measurements on the technical system, for example with high accuracy and/or high time resolution.

The training data is read in for the joint training of the discriminator DIS and the generator GEN. Training takes place by entering input values INP for the generator GEN.

The discriminator DIS and the generator GEN are in particular trained in alternation, wherein a specified cost function COST is minimized. Consequently, this is an iterative process. First, the discriminator DIS is trained based on the measurement data and/or simulation data. Then, the generator GEN is trained to generate values, wherein these output values of the generator are used as input values for the discriminator DIS. The discriminator DIS ascertains the “real/genuine” values and the “fake” values. Then, the discriminator DIS is trained again to improve the classification of the values. Thus, the generator GEN and the discriminator DIS are trained together. The alternating training is repeated until the generator GEN generates values that the discriminator DIS is unable to distinguish from the “genuine/real” values. For example, a quality criterion can be defined for this.

After the training, the trained generator GEN is output as a generative machine learning model GML for recording values of a physical variable of a technical system. The trained generative machine learning model GML can, for example, be used as a virtual sensor.

FIG. 5 is a schematic representation of a further exemplary embodiment of the method according to embodiments of the invention for recording a value of a physical variable of a first technical system TS1.

The first technical system TS1 can, for example, be a distillation column (or rectification column) for thermal separation of mixtures. A value V2 of a temperature PQ1_2 at the bottom of the distillation column is to be determined. For example, the temperature cannot be measured there or can only be measured with difficulty by means of a real sensor.

The temperature value PQ1_2 in particular depends on substance distribution and/or substance concentration within the distillation column TS1. For example, the temperature value V2 at the bottom of the distillation column can be estimated in dependence on a first value I1 of the substance concentration and/or in dependence on a first temperature value V1 at the upper end (top) of the distillation column. The estimation can take place by means of a generative machine learning model GML trained for this purpose.

The generative machine learning model GML can be trained for a second technical system TS2, for example, a second distillation column, as follows. The generative machine learning model GML is trained for a technical system that is at least similar to the real system. In other words, the generative machine learning model GML can in particular be trained for the same technical system or for another technical system with matching specified system specifications. Consequently, the first technical system TS1 and the second technical system TS2 can be the same system or the same as one another, wherein this is defined by the system specifications. A system specification relates, for example, to a type, a variable, etc. of the distillation column.

For example, the generative machine learning model GML can be trained for a second distillation column TS2 whose system specification corresponds to the system specification of the first distillation column.

Simulation data from a computer-aided simulation of the distillation process DP in the second distillation column is provided as training data. The simulation data comprises, for example, values for the substance concentration I2, values for a temperature PQ2_1 at the top of the column and values for a temperature PQ2_2 at the end of the second distillation column.

This simulation data can be used to train the generative machine learning model GML. The generative machine learning model GML is trained to reproduce the value of the temperature at the end of the column in dependence on the value of the temperature at the top of the column and/or the value of the substance concentration I2.

The generative machine learning model GML trained in this way can be applied for recording a value V2 of the temperature PQ1_2 at the bottom of the first distillation column. For this purpose, the generative machine learning model GML can, for example, be executed on a neural processing unit (NPU). Herein, at least one measured value V1, I1 of the first distillation column is transferred to the generative machine learning model GML as an input value. Thus, the generative machine learning model GML can be used to determine a value V2 of the temperature PQ1_2 at the bottom of the column in dependence on the value of the temperature PQ1_1 at the top of the column and/or in dependence on the value of the substance concentration I1. In particular, the generative machine learning model GML can be used to extrapolate values of the distillation process DP in the first distillation column TS1. Thus, the generative machine learning model GML can be used as a virtual sensor. Then, the generated value V2 of the temperature PQ1_2 at the bottom of the column can be output. For example, the value V2 can be displayed to an operator and/or transmitted to a controller of the distillation column to control the distillation process.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An apparatus for recording a value of a physical variable of a first technical system, wherein the first technical system includes a first system specification, comprising:
an interface which is configured to read in a measured value of a first physical variable of the first technical system recorded by means of a physical sensor,
a memory unit which is configured to store a generative machine learning model
wherein the generative machine learning model is configured to generate and output, in dependence on at least one value of a first physical variable of a second technical system, at least one value of a second physical variable of the second technical system,
wherein the second technical system is characterized by a second system specification and the second system specification at least partially coincides with the first system specification,
a measured value generator which is configured to generate, by the generative machine learning model, a value of a second physical variable of the first technical system in dependence on the measured value of the first physical variable, wherein the first physical variable of the first technical system corresponds to the first physical variable of the second technical system and the second physical variable of the first technical system corresponds to the second physical variable of the second technical system,
and
an output unit which is configured to output the generated value of the second physical variable of the first technical system.

2. The apparatus as claimed in claim 1, wherein the generative machine learning model is configured by generative adversarial networks.

3. The apparatus as claimed in claim 1, wherein the generative machine learning model is configured to generate, in dependence on at least one value of a first physical variable of the second technical system at a first time, at least one value of a second physical variable of this technical system at a second time, wherein the second time is later than the first time.

4. The apparatus as claimed in claim 1, wherein the value of the second physical variable of the first technical system cannot be measured directly or cannot be measured sufficiently by a physical sensor.

5. The apparatus as claimed in claim 1, wherein the generative machine learning model is configured based on simulation data of a computer-aided simulation of the second technical system, wherein the simulation data comprises at least one value of the first physical variable and at least one value of the second physical variable of the second technical system.

6. The apparatus as claimed in claim 1, wherein the generative machine learning model is configured based on measured values of the second technical system, wherein the measured values comprise at least one value of the first physical variable and at least one value of the second physical variable of the second technical system.

7. The apparatus as claimed in claim 1, wherein the apparatus comprises a computing unit for artificial intelligence.

8. The apparatus as claimed in claim 1, wherein the apparatus is realized as a virtual sensor.

9. A computer-implemented method for recording a value of a physical variable of a first technical system, wherein the first technical system includes a first system specification, with the method steps:
reading in a measured value of a first physical variable of the first technical system recorded by means of a physical sensor,
reading in a generative machine learning model, wherein
the generative machine learning model is configured to generate and output, in dependence on at least one value of a first physical variable of a second technical system, at least one value of a second physical variable of the second technical system,
and the second technical system is characterized by a second system specification and the second system specification at least partially coincides with the first system specification,
generating a value of a second physical variable of the first technical system in dependence on the measured value of the first physical variable by means of the generative machine learning model, wherein the first physical variable of the first technical system corresponds to the first physical variable of the second technical system and the second physical variable of the first technical system corresponds to the second physical variable of the second technical system,
and
outputting the generated value of the second physical variable of the first technical system.

10. A computer-implemented method for providing a generative machine learning model for use in the method as claimed in claim 9, with the method steps:
reading in training data of a technical system, wherein the training data comprises at least one value of a first physical variable and at least one value of a second physical variable of the technical system,
reading in a generative machine learning model,
training the generative machine learning model by means of the training data and a discriminator network such that the generative machine learning model generates and outputs the value of the second physical variable in dependence on the value of the first physical variable,
and
outputting the trained generative machine learning model for recording a value of a physical variable of a technical system.

11. The computer-implemented method as claimed in claim 10, wherein the training data is simulation data of a computer-aided simulation and/or measurement data of the technical system.

12. A computer program product, comprising a computer readable hardware storage device having computer readable program code stored therein, said program code executable by a processor of a computer system to implement a method, which is loaded directly into a programmable computer, comprising program code portions, which are suitable for performing the steps of the method as claimed in claim 1.
